(19) United States
(12) Patent Application Publication
(10) Pub. No.: US 2006/0288019 A1
(43) Pub. Date: Dec. 21, 2006

(54) Flexible data file format

(76) Inventors: Niclas Bauer, Malmo (SE); Peter Aulin, Malmo (SE); Michael Rosenberg, Sodra Sandby (SE); Mats Svensson, Lund (SE)

Correspondence Address: POTOMAC PATENT GROUP, PLLC, P. O. BOX 270, FREDERICKSBURG, VA, 22404, US

(21) Appl. No.: 11/250,652

(22) Filed: Oct. 14, 2005

Related U.S. Application Data
(60) Provisional application No. 60/685,581, filed on May 27, 2005.

(51) Int. Cl. G06F 7/00

(52) U.S. Cl. 707/100

(57) ABSTRACT

A data format includes a header, section information, and one or more sections. Each section includes binary data that is encoded independently of other sections, and the header and section information contains information about the sizes, load addresses, and encoding, e.g., encryption and/or compression, of the sections. The header and section information are arranged in an image having this format such that they are readable before the sections are processed. For example, the sections can be located in sequence after the header and the section information, in an order determined by their load addresses.

This application claims the benefit of the filing date of U.S. Provisional Patent Application No. 60/685,581, which was filed on May 27, 2005, and which is incorporated here by reference.

### BACKGROUND

This application relates to digital data files and more particularly to formats of such data files.

Various formats for object code and executable files for digital computers are currently available. The most widespread formats are the Common Object File Format (COFF) and the Executable and Linking Format (ELF). Both of these formats have been used for many years and in different variations in the WINDOWS and UNIX/Linux environments. For instance, Microsoft Corp. uses a variation of COFF called “PE COFF” (Portable Executable COFF) in its operating systems.

Both the COFF and the ELF are based on sections, which is to say that a COFF or ELF file is structured as a header, section information, and data organized in sections that specify different types of information. A “text” section, for instance, contains program code.

U.S. Patent Application Publication No. US 2005/0114391 by Corcoran et al. discloses a self-descriptive binary data structure called a microcode reconstruct and boot (MRB) image. The location of an individual data set may be identified by a data structure descriptor, which may be an advantage over ELF and COFF and other formats configured to include only a single executable. The format supports having multiple “modules” in a file, where a module is an executable piece of software or hardware modeled with a hardware description language. The format does not have sections that can contain any type of data, e.g., executable, binary, textual, etc., and coding sections is not described.

U.S. Pat. No. 6,694,393 to Sutter, Jr., describes a program file or other type of information file for use in an embedded processor system that is partially compressed in a host device and transferred to a non-volatile memory of the embedded system. A non-compressed header is used with memory sections that are compressed, although individualized compression of the sections is not described.

It will be understood that an embedded system is hardware and software that form a component of a larger system and that are expected to function substantially without human intervention. An example of an embedded system is a microcomputer and software stored in a read-only memory (ROM) that starts running the stored program when it is turned on and does not stop until it is turned off.

International Publication No. WO 2004/029837 by Holthe describes encapsulating multimedia content data, multimedia content description data, and program instruction code into an aggregated data representation comprising a hierarchical logical structure. Information about the multimedia content and description data and program instruction code is stored in a main header in the logical structure. Compression of content is supported in the sense that the format can contain, for example, a PNG-format picture and program code for reading it. The container format uses XML as notation. The format is hierarchical, supporting blocks in blocks, etc.

U.S. Pat. No. 5,548,759 to Lipe describes combining multiple files into a single file having an executable format to operate a hardware or software device. A header includes a resources table that identifies the location of non-executable files and executable files in a resources section. The format is simply a container format for organizing files, and one that does not support coding of files.

Software development methods are known for linking object code into executable programs, compiling object modules for storage in object module format for linking or combining with other object modules stored in library files to create executable programs.

Also known are program downloading methods for use in data processing systems, integrating non-program information and program information into an executable file that is used by a host processor to download the program to a selected co-processor.

Also known are methods for compressing and recovering binary execution files; image loading program storage media for loaders of operating systems, which load and map executable images into memory based on file formats of images; and executable file protection and execution methods involving incorporating protection descriptors into protected executable files and providing to interpreters for unprotecting and executing protected files.

The current de facto standards for object code and executable files have emerged from and matured on operating systems for server and desktop computers. Being de facto standards, the formats have found their way into embedded systems as well, but these formats have properties that make them inefficient in embedded environments. For example, the sections are not ordered by their memory location, which may lead to inefficient loading of code and data in some environments. In addition, object code often contains repetitive data, which results in redundancy and inefficient use of storage space.

Aspects of the use of object file formats in embedded processor systems, including versions of COFF, are described in Minda Zhang, “Analysis of Object File Formats For Embedded Systems”, June 1995, published at http://www.intel.com/design/intarch/papers/esc_file.pdf.

An embedded computer environment has many features that are not present in a desktop- or server-computer environment. For example, it is usually important that the sizes of binary images are kept low, as an embedded system usually has limited storage capacity. Thus, binary files should contain as little overhead as possible. It is also important that object code and data can be loaded efficiently, as processing power may be limited, especially in an embedded system. A lot of software today is sent across wireless communication links (e.g., wireless local area networks (WLANs), mobile telephony networks, etc.), and it is important that software can be sent in a secure manner. If a binary file format supports encryption, a higher level of safety can be achieved.

### SUMMARY

The new format for binary data described in this application is particularly useful in embedded systems as well as in other computer environments where efficiency is important. Greater efficiency in loading data can reduce response times in such systems, and space-efficient storage saves valuable memory.

In one aspect of this invention, there is provided a data image arranged in a format that includes at least one section, a header, and section information. The header contains a first information element that indicates a total size of the at least one section and a second information element that indicates a number of the sections. The section information includes a respective entry for each section, each entry including a third information element that indicates a length of the respective section and a fourth information element that indicates a load address of the respective section. The at least one section includes data that is encoded independently of the header, section information, and other sections. The header and the section information is arranged in the image such that the header and section information are readable before the at least one section.

In another aspect of this invention, there is provided a computer-readable medium containing a data image for loading into a memory in a processor system. The data image is arranged in a format that includes at least one section, a header, and section information. The header contains a first information element that indicates a total size of the at least one section and a second information element that indicates a number of the sections. The section information includes a respective entry for each section, each entry including a third information element that indicates a length of the respective section and a fourth information element that indicates a load address of the respective section. The at least one section includes data that is encoded independently of the header, section information, and other sections. The header and the section information are arranged in the image such that the header and section information are readable before the at least one section.

In yet another aspect of this invention, there is provided a method of converting a binary image into a converted image having a format. The method includes the steps of identifying at least one section in the binary image; coding each identified section according to a respective coding scheme; forming a header that indicates a total size of the at least one section and a number of the sections; forming section information having information about respective lengths, coding schemes, and load addresses of the identified sections; and arranging the header, section information, and identified sections in the converted image. The header and section information are arranged such that they are readable in the converted image before the sections, and the sections are arranged according to the section information.

### BRIEF DESCRIPTION OF THE DRAWINGS

The features, objects, and advantages of this invention will be understood by reading this description in conjunction with the drawings, in which:

FIG. 1A is a diagram of a data image having a format in accordance with aspects of this invention;

FIG. 1B is a diagram of a header of the data image of FIG. 1A;

FIG. 1C is a diagram of section information of the data image of FIG. 1A;

FIG. 2 is a block diagram of a processor system; and

FIG. 3 is a flow chart of a method of forming a data image in accordance with aspects of this invention.

### DETAILED DESCRIPTION

As described above, the binary data format described in this application is useful in processor systems, such as embedded systems, in which efficiency is important. Greater efficiency when loading software can lower response times in embedded systems and other computer systems, and space-efficient storage saves valuable memory.

The format described here includes a header, section information, and one or more sections. The section information contains the information for all sections, which is more advantageous than having each section include its own information, i.e., the information is concentrated rather than distributed across the sections. Furthermore, the section information contains information about the encoding of the sections.

Each section includes binary data that is encoded independently of other sections, and the header and section information contains information about the sizes, load addresses, and encoding, e.g., encryption and/or compression, of the sections. The header and section information are arranged in an image having this format such that they are readable before the sections are processed. For example, the sections can be located in sequence after the header and the section information, in an order determined by their load addresses.

Other arrangements are possible, of course. It is important only that the header and section information can be read before the rest of an image. The locations of the header and section information can be anywhere in the image, provided it is possible to access the header and section information before the rest of the image. Thus, the location of the header must be predetermined, or at least known to the software reading the image, so that the software “knows” where to look for the header. The location of the section information may also be “known” to the software, or the header can indicate the location.

Thus, it will be appreciated that the format described here, in contrast to prior data formats, supports individual coding of sections, where a section can contain any type of data, such as executable, binary, text, etc. Information about the sections is located in a header and section information at, for example, the beginning of the image, and so the information about the sections can be retrieved before the sections are read. Moreover, the format is a representation of a group of sections, coded independently and having minimal overhead, that is traversed sequentially in reading the image. Images in this format can be optimized in different aspects, depending on the coding scheme or schemes applied in the sections.

There are many possible applications of this format and its individually coded sections. For example, an operating system memory manager can load and unload sections of memory according to images in this format. It can also be used as a file format in which executable files are stored, and linkers and program loaders can be readily adapted to support (read, write, and interpret) the format. Object code and data can also be stored in this file format, with a program loader reading the stored information and processing stored sections accordingly. One example of such a program loader is described in U.S. patent application Ser. No. 11/040,798 filed on Jan. 22, 2005, by M. Svensson et al. for “Operating-System-Friendly Bootloader”.

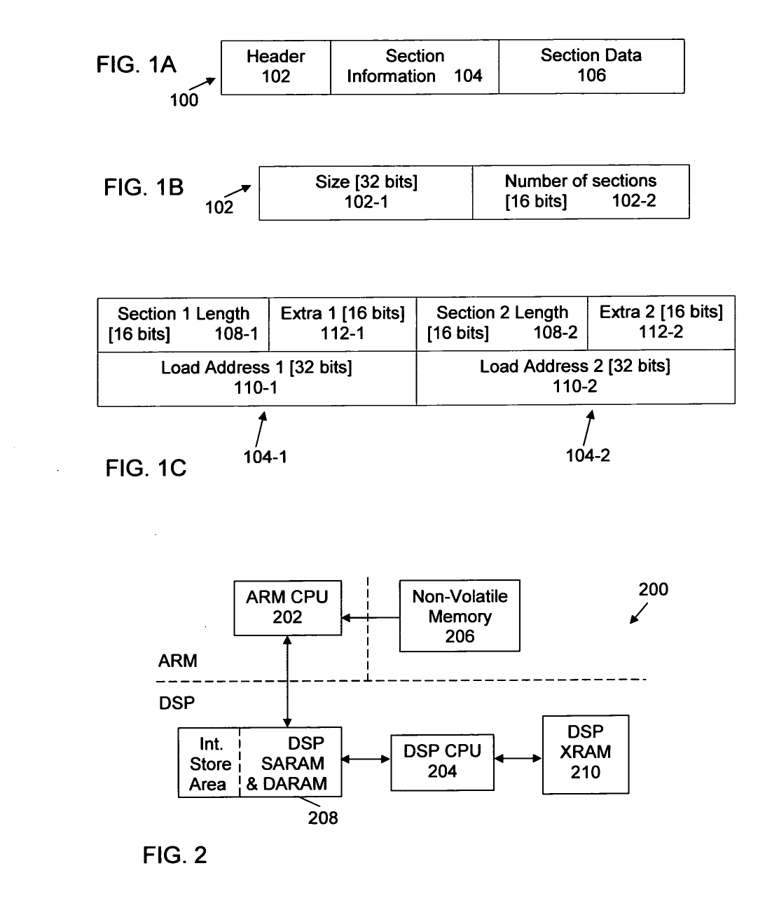

FIG. 1A depicts a binary data image 100 in this file format, including a header 102, section information 104, and section data 106. The section data 106 includes the data of the one or more sections included in the image 100.

As depicted in FIG. 1B, the header 102 contains a size information element 102-1 that indicates the total size of the sections 106 (in bytes, for example). The size element 102-1 may advantageously be a 32-bit unsigned integer, for example, and such an element is suitable for images having section data up to a total of four gigabytes (GB) in size. The header 102 also contains a number-of-sections information element 102-2, which may advantageously be a 16-bit unsigned integer, for example. It will be understood that other forms of these information elements can be used instead of the examples set forth here.

Each section in the section data 106 has a respective “section information” entry in the section information 104, and two such section information entries 104-1, 104-2 are depicted in FIG. 1C. The lengths of the respective sections, in bytes for example, are indicated by length information elements 108-1, 108-2, which may advantageously be 16-bit unsigned integers, for example. The load addresses of the sections are indicated by address information elements 110-1, 110-2, which may advantageously be 32-bit unsigned integers, for example. If desired, additional information related to a section can be indicated by extra information elements 112-1, 112-2, which may advantageously be 16 bits in length. It will be understood that other forms of these information elements can be used instead of the examples set forth here.

FIG. 2 depicts a multi-processor system 200 that includes a host processor 202 and a client processor 204 and that can advantageously use a binary image 100 having the format depicted in FIGS. 1A, 1B, 1C. It will be appreciated that although FIG. 2 shows one client processor 204, more can be provided, and it will further be appreciated that although FIG. 2 shows a multi-processor system, even only a single processor 202 can be provided. Moreover, the processor(s) may be any programmable electronic processor(s). In the example depicted in FIG. 2, the processor 202 is shown as the central processing unit (CPU) of an advanced RISC machine (ARM), and the processor 204 is shown as the CPU of a digital signal processor (DSP) device. The dashed line in FIG. 2 depicts the hardware boundary between the host and slave devices, in this example, the ARM and the DSP, and also a non-volatile memory 206. The memory 206 may be a ROM, a flash memory, or other type of non-volatile memory device, within which an image in the format depicted in FIGS. 1A-1C can be stored.

Most commercially available DSP devices include on-chip memories, and as indicated in FIG. 2, the DSP includes “internal” single-access RAM (SARAM) and dual-access RAM (DARAM) 208, as well as an “external” RAM (XRAM) 210. An intermediate storage area, indicated by the dashed line, may be defined within the memory 208. The arrows in FIG. 2 indicate access paths, e.g., busses and direct memory access (DMA) paths, between the CPUs and the memories, any one or more of which may store an image in the format depicted in FIGS. 1A-1C. The ARM host CPU 202 can access the non-volatile memory 206 and the SARAM and DARAM 208 of the DSP, but not the DSP's XRAM 210, and the DSP slave CPU 204 can access all of the RAMs 208, 210.

As depicted in FIG. 1A, the section information entry or entries 104 precede the data 106 of the section(s) in the image 100. The section data 106 is advantageously arranged in the image in a sequence, and it is preferable that the section data 106 as well as the section information entries 104 are arranged in order of the section load addresses 110, starting with the lowest address. It will be understood, however, that other orders are suitable, e.g., starting with the highest address, and that in general it is not necessary to order the section by their load addresses. The sections may be in an arbitrary order. As each section has a respective load address, the sections can appear in any order (e.g., by size, coding type, or whatever is suitable). It is currently believed, however, that the most efficient solution from a loading point of view is probably arranging the sections by load address in either descending or ascending order.

Having all section information entries 104 collected together in the image 100 advantageously simplifies system navigation through the image, and having all section data arranged in a sequence makes it possible to optimize loading of the sections. For instance, it is simple to split or concatenate sections when they are adjacent in memory. The ability to split sections can be useful, for instance, when a DMA transfer is to be set up. As there is always a small overhead when setting up a DMA transfer, a DMA unit can be used in an efficient way by arranging the size of the data to be transferred to be equal or close to the block sizes used by the DMA unit. As sections can be located sequentially in an image 100, it is simple to split a section into several suitable pieces before downloading it.

The extra information elements 112 in the section information 104 can be used in a variety of ways, for example to convey information about each section's coding, such as compression and/or encryption. It will be understood that compressing one or more sections makes the size of the image 100 smaller, and storage space can thus be saved. Encrypting one or more sections enables a higher level of security to be achieved, for instance, during download of a binary image 100 to a system.

The extra information elements 112 in the section information 104 can also be used in connection with digital signatures and watermarks. This can be an important application in terms of software security. Using one or more of the elements 112, a linker or post-linker tool can derive a signature/watermark for each section in an image, and a loader can read the signature/watermark and compare it to a section in question. In this way, the extra information elements enable the integrity of one or more sections of an image to be verified, i.e., that the image has not been patched or altered.

Decoding (e.g., decompression and/or decryption) of a section or sections requires some processing time to be expended when an image 100 is loaded into a system's memory. On the other hand, section encoding has many benefits, including for example more efficient memory usage and better security. These factors can thus be traded-off when building an image, and each section can be optimized for security/space/load-time, depending on the configuration and properties of a particular system.

The ability to individually encode sections provides many possibilities for optimization. Each section can be encoded independently using an arbitrary encoding scheme (compression, encryption, or whatever is preferred). It is possible to apply several encoding steps on a section (e.g., compression followed by encryption). This can be important, as different sections may have different properties, e.g., some sections may contain data that is suitable to compress and other sections may contain data that is sensitive and must be protected.

Having information about the sections collected in the header 102 and section information 104 simplifies optimization in a number of circumstances, for instance, if sections are to be loaded into memory. The block 104 lists all sections, preferably in order of memory location, and this makes memory loading efficient as there is no need to search through an image for section headers when loading.

The sequential location of sections in the image enables further optimizations to be done. For example, sections can be loaded in a burst when their memory locations are adjacent, and so it can be advantageous to arrange the processing system accordingly.

The format described here also supports streaming. All navigation information in an object file 100 is given in the header 102 and section information 104, which simplifies the configuration of a streaming session. All information about a file of the format can be given during the capability exchange phase, before the streaming session is started.

As described above, the format described here has many applications. For example, the format can be used as a file format for object code and/or data. Files having the format may be created directly by a linker. It is also believed that it is possible to convert COFF/ELF binary files and files in other formats to the above-described format using commercially available conversion tools. It is expected that the conversion tool would be executed as a post-link step in the build process, and the conversion tool could also combine several input files into one file having the above-described format.

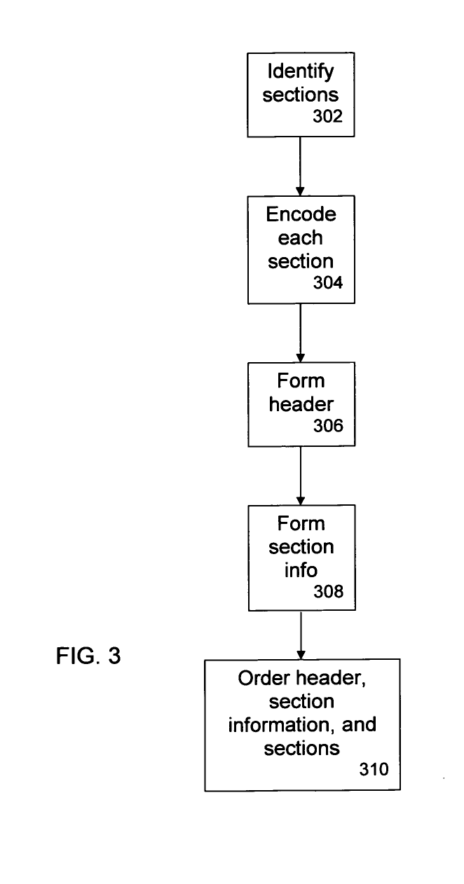

Converting a binary image, e.g., an image in COFF/ELF format, into an image having the format described in this application can be carried out in a number of ways, for example by a suitable post-linker conversion tool. An exemplary method is illustrated by the flow chart in FIG. 3, and includes a step of identifying all of the sections of the image to be converted (step 302). Each identified section is individually coded according to a specified coding scheme (step 304). A header having the information described above is formed (step 306), and section information having information about the respective lengths, encodings, and load addresses of the identified sections is formed (step 308). In step 310, the identified sections are arranged in the image according to the section information, e.g., in increasing order of load address, etc., and the header and section information are arranged in the converted image such that they are readable in the converted image before the sections.

As described above, the binary image to be converted may include a plurality of sections, and the sections are arranged in the converted image in a sequence after the header and the section information. For example, the sections can be arranged in an order determined by their respective load addresses. Coding an identified section can include encrypting the identified section, and the information about the encrypted section in the section information can further include an information element that describes the encryption.

The invention described here can be considered to be embodied entirely within any form of computer-readable storage medium having stored therein an appropriate set of data for use by or in connection with an instruction-execution system, apparatus, or device, such as a computer-based system, processor-containing system, or other system that can fetch data from a medium and execute or otherwise process the data. As used here, a “computer-readable medium” can be any means that can contain, store, communicate, propagate, or transport the data for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, an erasable programmable read-only memory (EPROM or Flash memory), and an optical fiber.

It is emphasized that the terms “comprises” and “comprising”, when used in this application, specify the presence of stated features, integers, steps, or components and do not preclude the presence or addition of one or more other features, integers, steps, components, or groups thereof.

The invention may be embodied in many different forms, not all of which are described above, and all such forms are contemplated to be within the scope of the invention. The particular embodiments described above are merely illustrative and should not be considered restrictive in any way. The scope of the invention is determined by the following claims, and all variations and equivalents that fall within the range of the claims are intended to be embraced therein.

What is claimed is:

1. A data image arranged in a format, comprising:
at least one section;
a header, wherein the header contains a first information element that indicates a total size of the at least one section and a second information element that indicates a number of the sections; and
section information, including a respective entry for each section, each entry including a third information element that indicates a length of the respective section and a fourth information element that indicates a load address of the respective section;
wherein the at least one section includes data that is encoded independently of the header, section information, and other sections; and the header and the section information is arranged in the image such that the header and section information are readable before the at least one section.

2. The data image of claim 1, wherein the first information element indicates the total size in bytes and is a 32-bit unsigned integer, and the second information element is a 16-bit unsigned integer.

3. The data image of claim 1, wherein the third information element is a 16-bit unsigned integer and the fourth information element is a 32-bit unsigned integer.

4. The data image of claim 1, wherein at least one entry of the section information further includes an extra information element.

5. The data image of claim 4, wherein the extra information element indicates a coding of the respective section.

6. The data image of claim 1, wherein the data image includes a plurality of sections.

7. The data image of claim 6, wherein the sections are arranged in a sequence after the header and the section information.

8. The data image of claim 7, wherein the sections are arranged in an order determined by their respective load addresses.

9. The data image of claim 6, wherein the data of at least one section is encrypted.

10. The data image of claim 9, wherein the entry for the at least one section further includes an extra information element that describes the encryption.

11. A computer-readable medium containing a data image for loading into a memory in a processor system, wherein the data image is arranged in a format that includes:
at least one section;
a header, wherein the header contains a first information element that indicates a total size of the at least one section and a second information element that indicates a number of the sections; and
section information, including a respective entry for each section, each entry including a third information element that indicates a length of the respective section and a fourth information element that indicates a load address of the respective section;
wherein the at least one section includes data that is encoded independently of the header, section information, and other sections; and the header and the section information is arranged in the image such that the header and section information are readable before the at least one section.

12. The computer readable medium of claim 11, wherein the data image is arranged in a format in which the first information element indicates the total size in bytes and is a 32-bit unsigned integer, and the second information element is a 16-bit unsigned integer.

13. The computer readable medium of claim 11, wherein the data image is arranged in a format in which the third information element is a 16-bit unsigned integer and the fourth information element is a 32-bit unsigned integer.

14. The computer readable medium of claim 11, wherein the data image is arranged in a format in which at least one entry of the section information further includes an extra information element.

15. The computer readable medium of claim 11, wherein the data image includes a plurality of sections.

16. The computer readable medium of claim 15, wherein the sections are arranged in a sequence after the header and the section information.

17. The computer readable medium of claim 16, wherein the sections are arranged in an order determined by their respective load addresses.

18. The computer readable medium of claim 15, wherein the data of at least one section is encrypted.

19. A method of converting a binary image into a converted image having a format, comprising the steps of:
identifying at least one section in the binary image;
coding each identified section according to a respective coding scheme;
forming a header that indicates a total size of the at least one section and a number of the sections;
forming section information having information about respective lengths, coding schemes, and load addresses of the identified sections; and
arranging the header, section information, and identified sections in the converted image, wherein the header and section information are arranged such that they are readable in the converted image before the sections, and the sections are arranged according to the section information.

20. The method of claim 19, wherein the binary image includes a plurality of sections, and the sections are arranged in the converted image in a sequence after the header and the section information.

21. The method of claim 20, wherein the sections are arranged in an order determined by their respective load addresses.

22. The method of claim 19, wherein coding an identified section includes encrypting the identified section.

23. The method of claim 22, wherein information about the encrypted section in the section information further includes an information element that describes the encryption.
